(19) United States
(12) Patent Application Publication
(10) Pub. No.: US 2008/0134563 A1
(43) Pub. Date: Jun. 12, 2008

(54) AUTOMATIC FISH HOOK SETTER

(76) Inventor: Tim Gunter, Vernal, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/864,827

(22) Filed: Sep. 28, 2007

Related U.S. Application Data
(60) Provisional application No. 60/847,899, filed on Sep. 29, 2006.

(51) Int. Cl. A01K 91/10; A01K 97/12

(52) U.S. Cl. 43/16; 43/15

(57) ABSTRACT

The present invention relates to a fishing device that automatically sets a fishing hook within the mouth of a fish when the fish bites on the hook. The automatic fish hook setting device comprises a housing, a fishing pole holder, a trigger mechanism, and a biasing mechanism. The fishing pole holder is adapted to hold a fishing pole therein. The trigger mechanism is configured to hold the fishing pole holder in a first position until a fish bites the fishing hook. When a fish bites the fishing hook, the trigger mechanism is disengaged and the biasing mechanism causes the fishing pole to quickly rotate to a second position, thereby setting the fishing hook within the mouth of the fish. An alarm mechanism is also disclosed. The alarm mechanism notifies a user when a fish has been caught using the automatic fish hook setting device.

### CROSS-REFERENCE TO RELATED APPLICATIONS

This application claims priority to and the benefit of U.S. Provisional Application No. 60/847,899, filed Sep. 29, 2006, the content of which is hereby incorporated by reference in its entirety.

### BACKGROUND OF THE INVENTION

1. The Field of the Invention

The present invention generally relates to fishing apparatuses. More specifically, the present invention generally relates to fishing apparatuses that can hold a fishing pole and automatically set a fishing hook.

2. The Relevant Technology

A fishing pole is typically comprised of a flexible rod with a spool of fishing line coupled to the rod at a proximal end, near a handle of the rod. The fishing line is guided to the distal end of the rod by loops on the rod. A hook is attached to the free end of the fishing line, and a lure is attached to the hook. When a fish bites the lure and pulls on the line, the fisherman jerks the fishing rod upward to set the hook into the mouth of the fish. However, waiting for a bite can require constant attention through long periods of inactivity. Additionally, great skill is required to properly set the hook in the mouth of a fish. If a fisherman does not pull on the fishing rod quickly enough when the fish bites, the hook will not be set. Similarly, if the fisherman pulls on the fishing rod too quickly or with too much force, the hook may not be properly set, thus allowing the fish to swim free. Furthermore, waiting for a bite on a fishing rod limits the number of fish that a fisherman can catch compared with the number that could be caught using multiple rods.

To avoid the above-identified drawbacks, a fisherman could use a fishing pole holder that automatically sets the hook in the mouth of a fish when the fish bites the lure. Automatic fish hook setters have been around for some time. Typically, automatic fish hook setters comprise a holder for receiving the handle of a fishing rod and a hook setting mechanism that quickly pulls the fishing rod back when a fish bites the lure. Such fish hook setters allow fishermen to relax or perform other tasks while waiting for a fish to bite on the lure. Furthermore, automatic fish hook setters reduce the high level of attention and skill normally required to catch a fish.

While fishing pole holders provide some benefits as described above, there are however, various drawbacks to the fish hook setters now known. For example, typical fish hook setters are often complex. Known fish hook setters are comprised of numerous parts, many of which move and require manipulation by a user. Even with an instructional manual, the complications associated with using a typical fish hook setter are not eliminated.

In light of the foregoing limitations, there is a continuing need for fishing apparatuses that overcome the above shortcomings.

### BRIEF SUMMARY OF THE INVENTION

In general, embodiments of the invention are concerned with a fish hook setter that has a hook setting mechanism to automatically set a fish hook in the mouth of a fish when the fish bites the lure. The fish hook setter allows a fisherman to confidently leave the fishing pole unattended, knowing that when a fish bites the lure, the hook setting mechanism will automatically set the hook in the mouth of the fish.

In one exemplary embodiment of the invention, a fish hook setter is provided having a housing, a fishing pole holder, a biasing mechanism, and a trigger mechanism. The housing includes a base portion for providing stability to the fish hook setter. The base portion can include apertures 118 through which stakes can be inserted and driven into the ground to secure the fish hook setter in place. The fish hook setter can also be secured in place with the use of other fasteners, such as screws or bolts.

An exemplary embodiment of the fish hook setter provides a fishing pole holder rotatably coupled to the housing. The fishing pole holder can be adapted to receive and securely maintain the handle portion of a fishing pole therein. The fishing pole holder can be selectively moved between a cast position and caught position to facilitate the automatic setting of the hook within the mouth of a fish. For example, after the fishing line and hook have been cast into the water, the handle of the fishing pole can be secured in the fishing pole holder in the cast position. The cast position typically orients the distal end of the fishing pole toward the water. Once a fish bites the lure, the fishing pole holder can move to the caught position, in which the distal end of the fishing pole is oriented away from the water.

An exemplary embodiment of the present invention further provides a trigger mechanism that can sense the bite of a fish on the lure. The trigger mechanism can be adapted to secure the fishing pole holder in the cast position. The trigger mechanism can further be adapted to engage a portion of the fishing line such that the tug on the fishing line caused by a fish biting on the lure disengages the trigger mechanism, thereby allowing the fishing pole holder to move to the caught position.

An exemplary embodiment of the present invention provides a biasing mechanism that can be coupled between the housing and the fishing pole holder to bias the fishing pole holder toward the caught position, for example. In one example embodiment, the biasing mechanism comprises a spring coupled to a rear portion of the housing and an upper, rear portion of the fishing pole holder. In this example embodiment, the spring biases the upper portion of the fishing pole holder toward the rear of the base portion, which can correspond to the caught position.

An exemplary embodiment of the present invention further provides an alarm mechanism to alert a fisherman when a fish has bitten on the lure. The alarm mechanism can be comprised of a mechanical alarm, such as a bell, or an electronic alarm, such as an audible signal produced by an electronic speaker or a visual signal produced by a device such as an LED, for example.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of the automatic fish hook setter of the present invention;

FIG. 2 is a side cross-sectional view of the automatic fish hook setter of FIG. 1;

FIG. 2 is a second side cross-sectional view of the automatic fish hook setter of FIG. 1.

### DETAILED DESCRIPTION OF THE PREFERRED EMBODIMENTS

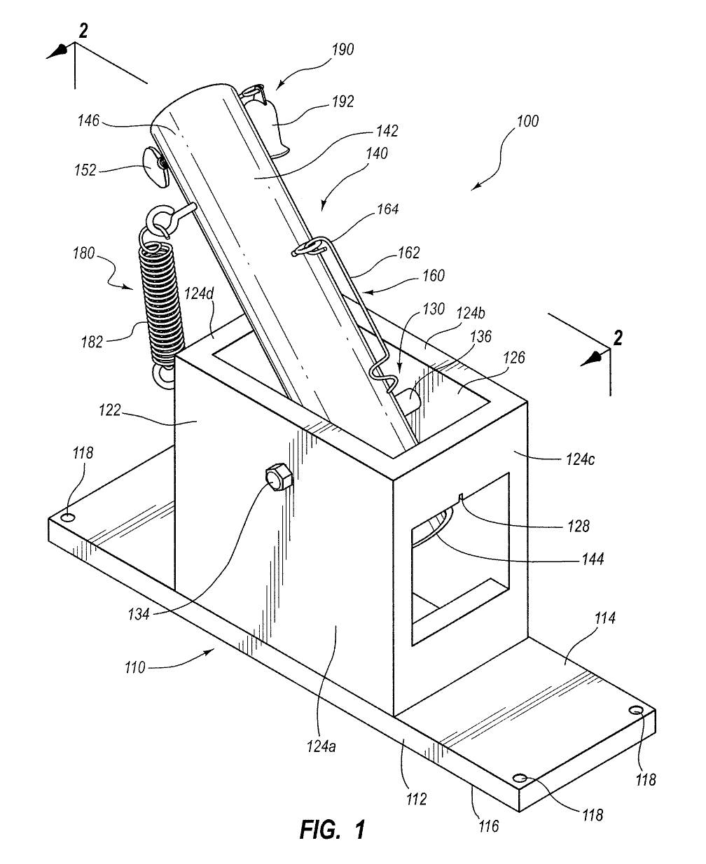

FIGS. 1-3 discloses an automatic fish hook setter 100 according to one embodiment of the invention. Automatic fish hook setter 100 is configured to securely hold fishing pole handle 202 of fishing pole 200. Furthermore, automatic fish hook setter 100 is capable of quickly pulling back fishing pole 200 to set fish hook 210 within the mouth of a fish when the fish bites on a lure 212 that is attached to fish hook 210. Automatic fish hook setter 100 can also be equipped with an alarm mechanism 150 to alert a fisherman that a fish has been caught.

Utilizing automatic fish hook setter 100 can provide numerous benefits for the user. For example, the attention required to be paid to the fishing line 208 is reduced. A user is able to cast fish hook 210, which is connected to fishing pole 200 by fishing line 208, into the water. With fishing line 208 cast, the user can then secure fishing pole handle 202 within automatic fish hook setter 100, knowing that automatic fish hook setter 100 will automatically set fish hook 210 within the mouth of a fish when the fish bites fish hook 210. Thus, the user does not have to continuously tend to fishing pole 200. Similarly, because automatic fish hook setter 100 is capable of setting fish hook 210 within the mouth of a fish, the skill required of the user to set fish hook 210 at the proper time and with the proper force is reduced or eliminated. Furthermore, since the user does not have to constantly tend fishing pole 200 to catch a fish, the user can relax or perform other tasks, such as casting and setting multiple fishing poles 200, each secured to its own automatic fish hook setter 100. In this manner, a user can simplify the fish catching process, reduce the skill and attention required to catch fish, and increase the likelihood of catching fish.

FIG. 1 illustrates a perspective view of an example embodiment of an automatic fish hook setter 100. In the illustrated embodiment, automatic fish hook setter 100 includes a housing 110, a fishing pole holder 140, a trigger mechanism 160, and a biasing mechanism 180. Automatic fish hook setter 100 can also include an alarm mechanism 190 to alert a fisherman when a fish has been caught.

Housing 110 is configured to provide structural support for automatic fish hook setter 100. Housing 110 can comprise a metal material, such as steel or aluminum, or can comprise some other structural material such as reinforced plastic or composite, or some combination thereof. According to the illustrated embodiment of the invention, housing 110 comprises a base portion 112 and an upper portion 122 mounted on base portion 112. Base portion 112 is configured to provide stability to automatic fish hook setter 100. Base portion 112 comprises four apertures 118 disposed in opposing corners of base portion 112. However, it will be appreciated that base portion 112 can include more or less than four apertures 118. Similarly, it will be appreciated that apertures 118 can be located in various positions on base portion 112. In the illustrated embodiment, apertures 118 extend through a top surface 114 and a bottom surface 116 of base portion 112. Apertures 118 are sized and configured to receive securing members 120 therethrough to couple automatic fish hook setter 100 to a support structure, such as a boat or the ground. Securing members 120 can comprise nails, screws, bolts, stakes, or other fasteners that can securely couple and maintain automatic fish hook setter 100 in place.

Upper portion 122 of housing 110 is configured to rotatably support fishing pole holder 140 in various desired orientations. In the illustrated embodiment, upper portion 122 is comprised of multiple upright wall members 124a-d, generally configured in a rectangular shape defining an interior cavity and having a top opening 126. It will be appreciated that upright wall members 124 can be configured so that upper portion 122 is circular, oval, parabolic, triangular, or some other shape. Additionally, various other components of automatic fish hook setter 100 can be coupled to upper portion 122. For example, pivot assembly 130, trigger mechanism 160, biasing mechanism 180, and alarm mechanism 190 can be coupled to upper portion 122 as will be described in greater detail below. It is also contemplated that base portion 112 and upper portion 122 can be formed as a unitary piece.

FIG. 1 illustrates pivot assembly 130. The components of pivot assembly 130 can comprise a metal material, such as steel or aluminum, or can comprise some other structural material such as reinforced plastic or composite, or some combination thereof. In the illustrated embodiment, pivot assembly 130 comprises a cross bar 132, fasteners 134, and washers 136. Pivot assembly 130 is mounted to upper portion 122 between opposing upright wall members 124a, b by fasteners 134. Fasteners 134 can comprise screws, bolts, nails, solder, adhesives such as glue, and the like. Fishing pole holder 140 is mounted on pivot assembly 130 such that fishing pole holder 140 can rotate between a first position and a second position. In the illustrated embodiment, cross bar 132 extends through a portion of fishing pole holder 140 to couple fishing pole holder 140 to pivot assembly 130. Washers 136 are disposed on crass bar on either side of fishing pole holder 140 to limit the lateral movement of fishing pole holder 140 between upright wall members 124a, b.

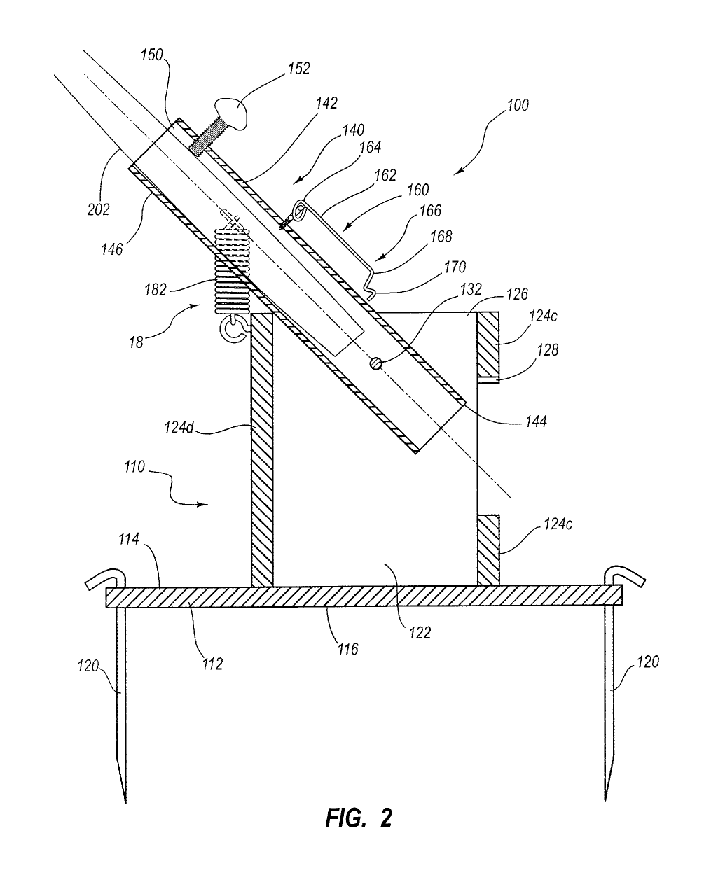

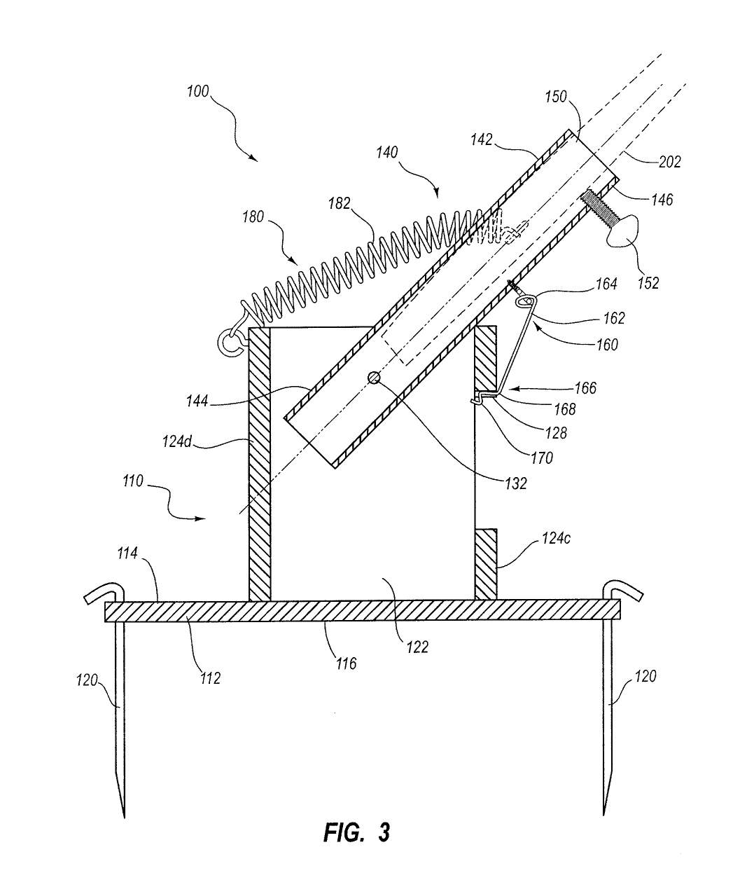

As noted above, automatic fish hook setter 100 includes fishing pole holder 140 that is rotatably mounted on pivot assembly 130 such that fishing pole holder 140 can rotate between a first position and a second position. Upright wall members 124c, d can assist in limiting the rotation of fishing pole holder 140 to the area between opposing upright wall members 124c, d. For example, fishing pole holder 140 can be in the first position when it is adjacent to upright wall member 124c as seen in FIG. 3 and can be in the second position when it is adjacent to upright wall member 124d as seen in FIGS. 1 and 2. In the illustrated embodiment, the first position is the cast position and the second position is the caught position.

According to the illustrated embodiment, fishing pole holder 140 comprises a tube member 142 having mounting holes 148 disposed on opposing sides of the tube member 142. Mounting holes 148 can be sized and configured to receive cross bar 132 of pivot assembly 130 therethrough. In the illustrated embodiment, cross bar 132 is fixedly coupled to housing 110 such that cross bar 132 remains stationary relative to housing 110. In this configuration, fishing pole holder 140 rotates about and relative to cross bar 132. It is contemplated within the scope of the invention that fishing pole holder 140 can be coupled to pivot assembly 130 in other manners that allow rotation of fishing pole holder 140. For instance, cross bar 132 of pivot assembly 130 can be replaced with multiple bars that extend from opposing upright wall members 124a, b and couple to fishing pole holder 140 rather than extending through tube member 142. Likewise, fishing pole holder 140 can comprise a clamp mounted on an outer surface of tube member 142 for coupling to cross bar 132. Moreover, cross bar 132 can be fixedly couple to fishing pole holder 140 and rotatably coupled to housing 110 such that cross bar 132 and fishing pole holder 140 rotate relative to housing 110.

Fishing pole holder 140 has a proximal end 144 and a distal end 146. As illustrated in the example embodiment, at distal end 146 of fishing pole holder 140 is a receiving portion 150 into which fishing pole handle 202 can be inserted. Receiving portion 150 can include a coupler 152 for securely maintaining fishing pole handle 202 within receiving portion 150. Coupler 152 can comprise a bolt or screw that extends through a side of fishing pole holder 140. With fishing pole handle 202 placed within receiving portion 150, coupler 152 can be tightened to secure fishing pole 200 within fishing pole holder 140. In alternative embodiments, receiving portion 150 can be sized and configured to frictionally retain fishing pole handle 202 therein without the need for coupler 152. In the example embodiment, cross bar 132 acts as a stopper to limit how far fishing pole handle 202 can be inserted into receiving portion 150. Coupler 152 can also comprise other fastening devices, such as a leaf spring disposed within receiving portion 150 to securely maintain fishing pole handle 202 within receiving portion 150.

Automatic fish hook setter 100 includes trigger mechanism 160. Trigger mechanism 160 is configured to secure fishing pole holder 140 in the first position, i.e., cast position. Trigger mechanism 160 is also configured to engage fishing line 208 such that when a fish bites fish hook 210, trigger mechanism 160 is actuated, thus allowing automatic fish hook setter 100 to set fish hook 210 in the mouth of the fish. Trigger mechanism 160 can comprise a metal material, such as steel or aluminum, or can comprise some other structural material such as reinforced plastic or composite, rope, string, or some combination thereof. In the illustrated embodiment, trigger mechanism 160 comprises lever 162, catch portion 168, and loop portion 170.

Lever 162 of trigger mechanism 160 has a first end 164 and a second end 166. First end 164 of lever 162 is hingedly coupled to the distal end 146 of fishing pole holder 140 such that second end 166 of lever 162 can move relative to first end 164 of lever 162. Second end 166 of lever 162 comprises a catch portion 168 and a loop portion 170. Catch portion 168 is configured to selectively engage abutment 128 of upper portion 122 of housing 110 when fishing pole holder 140 is positioned in the first position, i.e., the cast position. Engagement of catch portion 168 with abutment 128 prevents rotation of fishing pole holder 140 from the first position to the second position, i.e., the caught position. It will be appreciated that catch portion 168 can be engaged with and an abutment 128 on base portion 112. Loop portion 170 of lever 162 is configured to have a portion of fishing line 208 from fishing pole 200 wrapped thereabout.

Automatic fish hook setter 100 further provides a biasing mechanism 180. Biasing mechanism 180 comprises a biasing member 182 having a first end 184 and a second end 186. In the illustrated embodiment, the first end 184 of biasing member 182 is coupled to distal end 146 of fishing pole holder 140. The second end 186 of biasing member 182 is coupled to upper portion 122 of housing 110. Biasing member 182 is configured to bias fishing pole holder 140 toward the second position, i.e., caught position. In the illustrated embodiment, biasing member 182 comprises a tension coil spring. In alternative embodiments, second end 186 of biasing member 182 can be coupled to base portion 112 of housing 110. In yet other embodiments, biasing member 182 can comprise a leaf spring or compression spring disposed between fishing pole holder 140 and one of upright wall members 124 or base portion 112 to bias fishing pole holder 140 to the second position. It is also contemplated within the scope of the present invention, that the force exerted by biasing member 182 on fishing pole holder 140 can be varied, for instance by changing biasing member 182, i.e., changing from a spring with a given tension to a spring with a different tension. It is contemplated that biasing member 182 can be changed based on the fishing conditions. Fishing conditions that may necessitate a change is the strength of biasing member 182 can include location, such as ocean, river, or stream, or the type and size of fish sought to be caught.

In some embodiments, automatic fish hook setter 100 includes an alarm mechanism 190. Alarm mechanism 190 is configured to notify a user when a fish has been caught using automatic fish hook setter 100. Alarm mechanism 190 can comprise a mechanical device that sounds a signal when a fish has been caught. In the illustrated embodiment, alarm mechanism 190 comprises a bell 192 coupled to the distal end 146 of fishing pole holder 140. As fishing pole holder 140 is rotated between the first position and the second position, bell 192 rings, thus notifying the user that a fish has been caught. In alternative embodiments, alarm mechanism 190 comprises an electronic device that sounds a signal when fishing pole holder 140 moves from the first position to the second position. Alarm can also comprise other electrical devices, such as an LED or other illumination device. Alarm can also comprise other mechanical or electrical devices, or combination thereof, that are capable of notifying a user when a fish has been caught.

In use, fishing pole holder 140 is rotated to the first position, i.e., cast position. Rotation of fishing pole holder 140 to the first position is against the biasing force produced by biasing member 182. Thus, as fishing pole holder 140 is rotated to the first position, potential energy is stored in biasing member 182. With fishing pole holder 140 in the first position, catch portion 168 of lever 162 can be engaged with abutment 128 of housing 110. Fish hook 210, which is attached to fishing pole 200 by fishing line 208, is then cast into the water. Fishing pole handle 202 is then inserted into and secured within receiving portion 150. A portion of fishing line 208 is then wrapped around loop portion 170 of lever 162. With fishing, pole 200 and automatic fish hook setter 100 thus configured, a user can relax or engage in other activities rather than constantly tending to fishing pole 200. When a fish bites fish hook 210, fishing line 208 tugs against loop portion 170 causing catch portion 168 of lever 162 to disengage from abutment 128 of housing 110. With lever 162 disengaged from housing 110, fishing pole holder 140 is free to rotate under the influence of biasing member 182. The potential energy stored in biasing member 182 causes fishing pole holder 140, and thus fishing pole 200, to rotate quickly from the first position to the second position, i.e., from the cast position to the caught position. The quick rotation of fishing pole 200 in turn causes a quick jerk on fishing line 208 and fish hook 210, thereby setting fish hook 210 within the mouth of the fish. The rotation of fishing pole holder 140 from the first position to the second position also triggers alarm mechanism 190, which notifies the user that a fish has been caught using the automatic fish hook setter 100. The user can then reel in the fish.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An automatic fish hook setting device, comprising:
a housing adapted to be secured to a support structure;
a fishing pole holder coupled to the housing, the fishing pole holder being adapted to move between a first position and a second position, the fishing pole holder also being adapted to maintain at least a portion of a handle of a fishing pole therein;
a trigger mechanism coupled to the fishing pole holder, the trigger mechanism being adapted to selectively secure the fishing pole holder in the first position and sense when a fish bites on a hook that is linked to the fishing pole; and
a biasing mechanism coupled to the housing and the fishing pole holder, the biasing mechanism being adapted to bias the fishing pole holder toward the second position.

2. An automatic fish hook setting device as recited in claim 1, further comprising a pivot assembly mounted to the housing.

3. An automatic fish hook setting device as recited in claim 2, wherein the fishing pole holder is mounted on the pivot assembly, the fishing pole holder being adapted to rotate on the pivot assembly between the first and second positions.

4. An automatic fish hook setting device as recited in claim 1, wherein the first position is a cast position and the second position is a caught position.

5. An automatic fish hook setting device as recited in claim 4, wherein the biasing mechanism causes the fishing pole holder to move from the cast position to the caught position when the fish bites on the hook linked to the fishing pole.

6. An automatic fish hook setting device as recited in claim 1, wherein the trigger mechanism engages an abutment of the housing to selectively secure the fishing pole holder in the first position.

7. An automatic fish hook setting device as recited in claim 1, wherein the biasing mechanism comprises a coil spring.

8. An automatic fish hook setting device as recited in claim 1, wherein the housing comprises at least one upright wall member that at least partially defines an interior cavity in the housing, a portion of the fishing pole holder being disposed within the interior cavity of the housing.

9. An automatic fish hook setting device, comprising:
a housing having a base portion and an upper portion, the upper portion having at least one upright wall member that at least partially defines an interior cavity in the housing;
a pivot assembly mounted within the interior cavity of the housing, the pivot assembly having a cross bar that is coupled to the at least one upright wall member;
a fishing pole holder rotatably mounted on the cross bar of the pivot assembly, the fishing pole holder being adapted to rotate on the cross bar between a first position and a second position, the fishing pole holder also being adapted to retain a handle of a fishing pole;
a trigger mechanism coupled to the fishing pole holder, the trigger mechanism being adapted to selectively couple a distal end the fishing pole holder to the housing, the trigger mechanism having a loop portion for engaging fishing line linked to the fishing pole; and
a biasing mechanism coupled to the housing and the fishing pole holder.

10. An automatic fish hook setting device as recited in claim 9, wherein the trigger mechanism has a catch portion and the at least one upright wall member has an abutment, the catch portion and the abutment being adapted to engage one another to selectively couple the distal end of the fishing pole holder to the housing.

11. An automatic fish hook setting device as recited in claim 10, wherein the catch portion is adapted to disengage the abutment when a fish bites on a hook linked to the fishing line engaged with the loop portion of the trigger mechanism.

12. An automatic fish hook setting device as recited in claim 11, wherein the biasing mechanism biases the fishing pole holder from the first position to the second position when the catch portion is disengaged from the abutment.

13. An automatic fish hook setting device as recited in claim 9, wherein the cross bar of the pivot assembly extends through the fishing pole holder.

14. An automatic fish hook setting device as recited in claim 9, further comprising an alarm mechanism.

15. An automatic fish hook setting device as recited in claim 9, wherein the biasing mechanism comprises a resilient member.

16. An automatic fish hook setting device, comprising:
a housing, the housing comprising:
a base portion adapted to be coupled to a support structure; and
an upper portion having a plurality of upright wall members, one of the upright wall members having an abutment;
a fishing pole holder rotatably mounted within the upper portion of the housing, the fishing pole holder having a receiving portion adapted to retain a handle of a fishing pole therein, the fishing pole holder being adapted to rotate from a first position to a second position;
a trigger mechanism coupled to the fishing pole holder, the trigger mechanism being adapted to selectively secure the fishing pole holder in the first position;
a biasing mechanism coupled to the housing and the fishing pole holder, the biasing mechanism being adapted to bias the fishing pole holder toward the second position when a fish bites on a hook, the hook being linked to the fishing pole by fishing line; and
an alarm mechanism coupled to at least one of the fishing pole holder and the housing.

17. An automatic fish hook setting device as recited in claim 16, wherein the alarm mechanism comprises a bell coupled to an end of the fishing pole holder, the bell being adapted to ring when the fishing pole holder moves between the first and second positions.

18. An automatic fish hook setting device 17, wherein the alarm mechanism comprises an electronic device, the electronic device being adapted to signal a user when the fishing pole holder moves between the first position and the second position.

19. An automatic fish hook setting device 16, wherein the trigger mechanism comprises a loop portion, the loop portion being adapted to have the fishing line wrapped thereon, wherein the trigger mechanism allows the fishing pole holder to move from the first position to the second position when the fish bites the hook.

20. An automatic fish hook setting device 16, wherein the biasing mechanism comprises at least one of a coil spring, a leaf spring, a compression spring, a piston, and magnets.
